(19) United States
(12) Patent Application Publication
(10) Pub. No.: US 2008/0278525 A1
(43) Pub. Date: Nov. 13, 2008

(54) Height-adjusting foolproof apparatus for a printing module

(75) Inventors: Hsien-Chang Lin, Taipei Hsien (TW); Chih-Te Yu, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation.

(21) Appl. No.: 11/798,048

(22) Filed: May 9, 2007

(51) Int. Cl. B41M 1/12

(52) U.S. Cl. 347/8

(57) ABSTRACT

A height-adjusting foolproof apparatus for a printing module used in a large ink-jet printer comprises a first adjusting member in connection with a printing module for moving the printing module vertically and a second adjusting member in connection with the large ink-jet printer for presetting the height of the printing module according to the thickness or hardness of a material. After the second adjusting member is adjusted to the position of the preset height, the first adjusting member together with the printing module are leveled downward until the first adjusting member is against a protrusion of the second adjusting member, so that the printing module is pulled at the preset height.

### FIELD OF THE INVENTION

The present invention relates to a height-adjusting apparatus for a printing module and, more particularly, to a height-adjusting foolproof apparatus for pre-adjusting the height of the printing module, which has been used in a large ink-jet printer, according to the thickness or hardness of the materials.

### BACKGROUND OF THE INVENTION

A controllable printing module is usually disposed on the sliding platform of a conventional large ink-jet printer and able to be moved to and fro. A plurality of ink cartridges are disposed within the printing module and a plurality of printing heads corresponding to the ink cartridges are disposed below the printing module. After the ink is sprayed from nozzles of the printing heads to materials, ultraviolet light is projected downward from a projecting device disposed on one lateral side of the printing module to coagulate ink rapidly, so that the printing module is prevented from contacting the un-coagulated ink during the printing module is moved and thus the printing quality can be guaranteed.

In addition to paper, different kinds of materials can be printed in a large ink-jet printer, such as acrylic, corrugated board, canvas, aluminum, steel, tiles, plastic, wood, leather, glass, mesh, fabric, vinyl and so on, thus, it is necessary for operators to adjust the height of the printing module according to the thickness or hardness of the materials. For example, if a thicker material is to be printed, the height of the printing module should be enlarged previously, and if a thinner material is printed, the height of the printing module should be reduced correspondingly.

Conventionally, before materials are printed, operators adjust approximately the height of the printing module by their own judgments according to the thickness or hardness of the materials. Thus, it is not precise to adjust the height of the printing module by their judgments. The consequence of the action leads to the damage to the printing module or the materials to be printed because the printing module collides with the materials to be printed. Thus, although a variety of materials mentioned above can be printed by using a conventional large ink-jet printer, it is still difficult for operators to adjust precisely the height of the printing module, where is the distance between the printing module and the materials to be printed, according to the thickness or hardness of the materials.

In order to overcome all disadvantages described above, there is a need for operators to preset the printing module used in a large ink-jet printer at the corrected height according to the thickness or hardness of the materials to be printed, that is, the distance between the printing module and the materials to be printed can be precisely adjusted and the best printing quality achieved, the motive of the inventor is to try and develop the present invention after hard research.

### SUMMARY OF THE INVENTION

An object of the present invention is to provide a height-adjusting foolproof apparatus used in a large ink-jet printer, by which the most appropriate height of the printing module can be preset according to the thickness or hardness of the materials to be printed by providing a first adjusting member in connection with the printer module and a second adjusting module in connection with the large ink-jet printer.

In order to achieve the aforementioned object, the present invention provides a height-adjusting foolproof apparatus for a printing module used in a large ink-jet printer, which comprises a first adjusting member in connection with a printing module for moving the printing module vertically and a second adjusting member in connection with a large ink-jet printer for presetting the height of the printing module according to the thickness or hardness of a material. After the second adjusting member is adjusted to the position of the preset height, the first adjusting member together with the printing module are leveled downward until the first adjusting member is against a protrusion of the second adjusting member, so that the printing module is pulled at the preset height.

Other objects, advantages and novel features of this invention will be apparent after reading the following detailed description when taken in conjunction with the accompanying drawings.

### BRIEF DESCRIPTION OF THE DRAWINGS

FIG. 1 is an exploded schematic view showing the elements of a first embodiment of the present invention;

FIG. 2 is a schematic view showing the assembly of the first embodiment of the present invention;

FIG. 3 is a schematic view showing a using state of the first embodiment of the present invention;

FIG. 4 is an exploded schematic view showing the elements of a second embodiment of the present invention;

FIG. 5 is a schematic view showing the assembly of the second embodiment of the present invention; and

FIG. 6 is a schematic view showing a using state of the second embodiment of the present invention.

### DETAILED DESCRIPTION OF THE PREFERRED EMBODIMENT

The present invention provides a height-adjusting foolproof apparatus for a printing module used in a large ink-jet printer, comprising a first adjusting member 11 in connection with the printing module for moving the printing module vertically during adjustment and a second adjusting member 12 fixed in the printer for presetting the height of the printing module according to the thickness or hardness of materials.

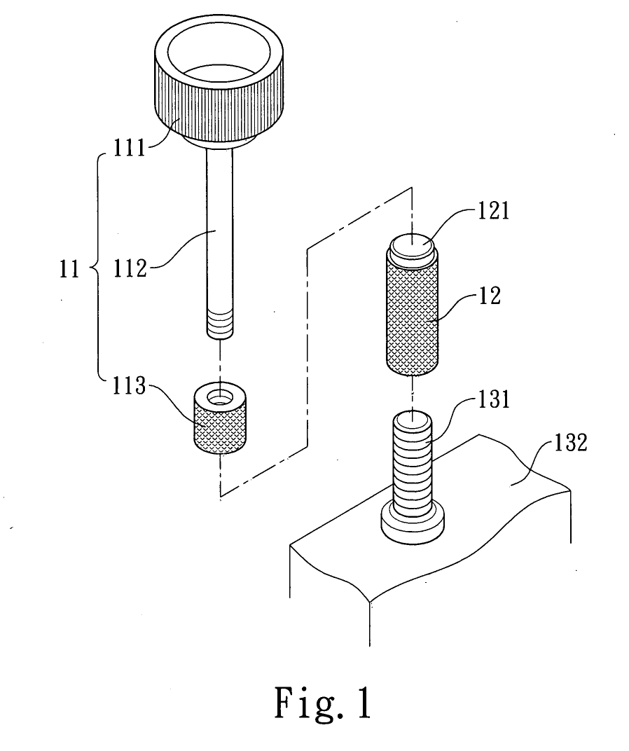

FIGS. 1-3 shows a first embodiment according to the present invention, which provides a height-adjusting foolproof apparatus for a printing module used in a large jet-ink printer. The height-adjusting foolproof apparatus comprises a first adjusting member 11 and a second adjusting member 12. As shown in FIG. 1 of the first embodiment, the first adjusting member 11 includes a turnable handle 111, a first toothed rack 112, and a nut 113, while the second adjusting member 12 includes a second toothed rack 131 and a base 132. The second adjusting member 12 is fixed to the printer via the second toothed rack 131 and the base 132. The first toothed rack 112 of the first adjusting member 11 is connected with the turnable handle 111, and the nut 113 is partially screwed with the first toothed rack 112. The unscrewed space within the nut 113 is used for covering a protrusion 121 on the central topside of the second adjusting member 12. The second adjusting member 12 is screwed with the second toothed rack 131 in connection with the base 132, so that the second adjusting member 12 can be connected with the printer.

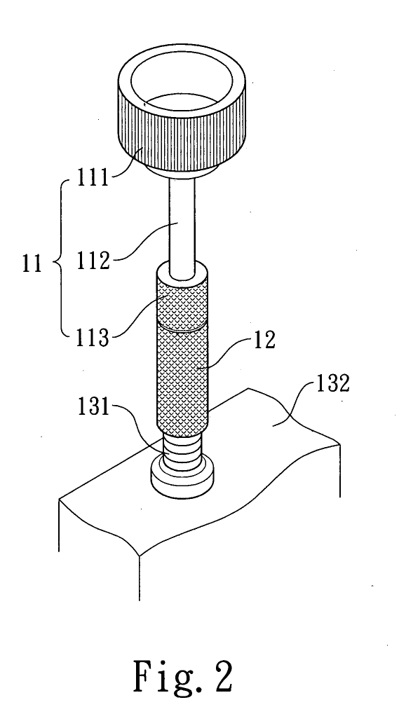

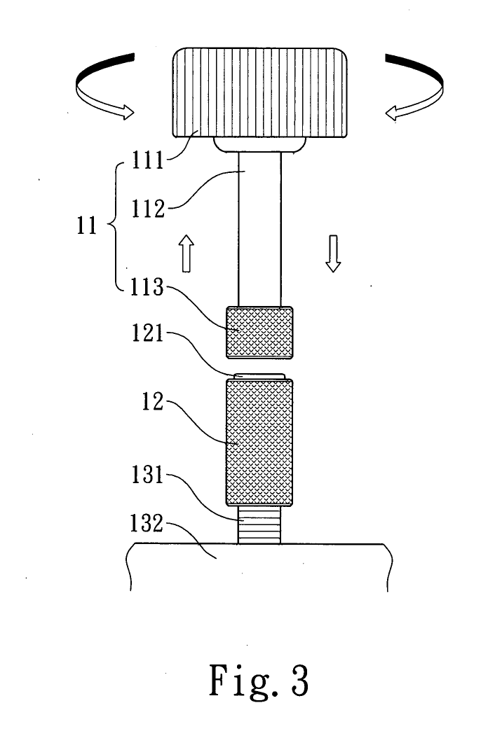

As shown in FIG. 2, the first adjusting member 11 is in connection with the printing module while the second adjusting member 12 is in connection with the printer. As shown in FIG. 3, when in practice, the printing module is first moved upward by rotating the turnable handle 111 of the first adjusting member 11. Then the second adjusting member 12 is moved upward or downward to the position of the preset height of the printing module according to the thickness or hardness of the materials to be printed by rotating the second adjusting member 12. When the second adjusting member 12 is pulled up to the position of preset height of the printing module, the printing module is leveled downward by rotating the turnable handle 111 of the first adjusting member 11. When the protrusion 121 of the second adjusting member 12 is covered by the unscrewed space within the nut 113 of the first adjusting member 11, the protrusion 121 is against the bottom end of the first toothed rack 112 within the nut 113, so that the first adjusting member 11 cannot further be leveled downward and the printing module in connection with the first adjusting member 11 is moved to the position of the preset height.

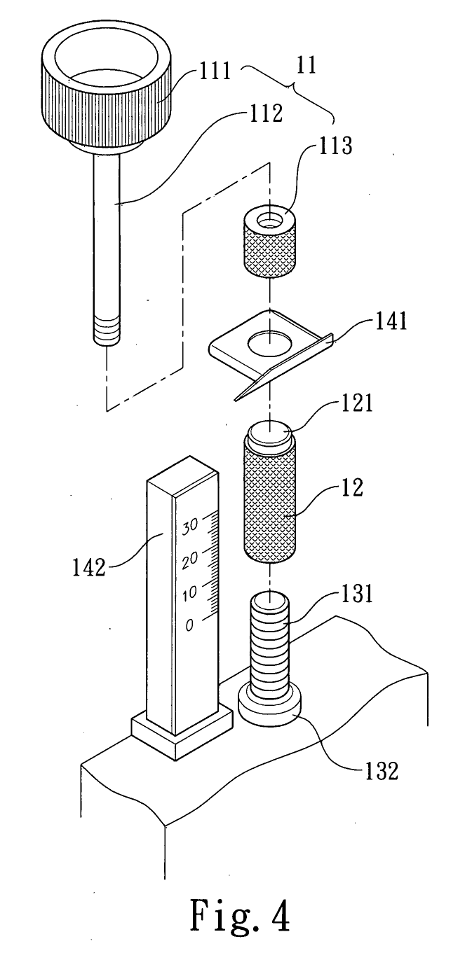

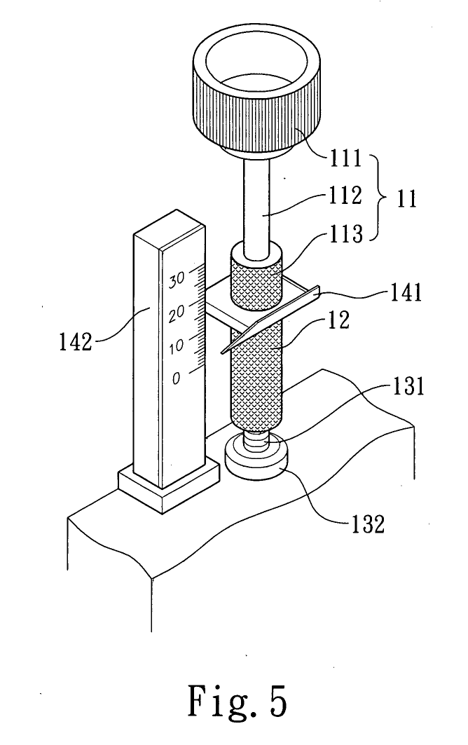

FIGS. 4-6 shows a second embodiment according to the present invention, which provides a height-adjusting foolproof apparatus for a printing module used in a large jet-ink printer. For the purpose of describing it conveniently, the same number will be assigned to the same structure mentioned in the first embodiment. The difference between the first embodiment and this embodiment is that a ruler 141 and an indicator 142 are further provided in the second embodiment. The ruler 141 is fixed to the printer for showing the precise height, and the indicator 142 is connected with the protrusion 121 of the second adjusting member 12 via a central hole and can be vertically moved together with the second adjusting member 12. Together with the scale on the ruler 141, the indicator 142 can be used for indicating the preset height of the printing module during the second adjusting member 12 is adjusted.

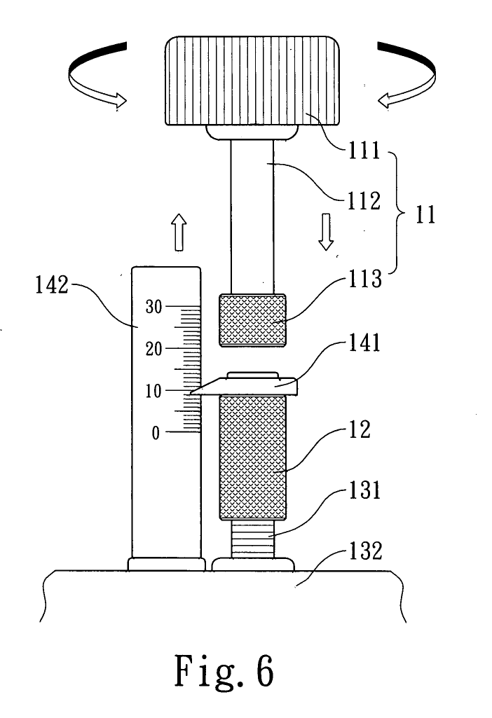

As shown in FIG. 6, when in practice, the printing module is first moved upward by rotating the turnable handle 111 of the first adjusting member 11. Then the second adjusting member 12 is pulled up to the position corresponding to the preset height of the printing module according to the thickness or hardness of the materials to be printed by rotating the second adjusting member 12.

In this embodiment, the distance between the printing module and the materials to be printed can be adjusted precisely by the use of the indicator 142 on the second adjusting member 12 together with the scale of the ruler 141 fixed to the printer. For example, operators can predetermine the most appropriate distance between the printing module and the materials to be printed according to the thickness or hardness of the materials. And the most appropriate height of the printing module is equal to the sum of the most appropriate distance between the printing module and the material to be printed and the thickness of the material itself. When the second adjusting member 12 is pulled up to the position of preset height of the printing module, the printing module is leveled downward by rotating the turnable handle 111 of the first adjusting member 11. When the protrusion 121 of the second adjusting member 12 is covered by the unscrewed space within the nut 113 of the first adjusting member 11, the protrusion 121 is against the bottom end of the first toothed rack 112 within the nut 113, so that the first adjusting member 11 cannot be further leveled downward and the printing module in connection with the first adjusting member 11 is at the preset position.

Thereby, the present invention has following advantages:
1. The present invention can provide a height-adjusting foolproof apparatus used in a large ink-jet printer, wherein a first adjusting member and a second adjusting member are provided for presetting the height of the printing module according to the thickness of the materials to be printed, so that the possible damage resulting from the printing module colliding with the materials to be printed due to erroneous judgments can be prevented.
2. The present invention also can provide a height-adjusting foolproof apparatus used in a large ink-jet printer, wherein an indicator and a ruler are provided for operators to adjust precisely the height of the printing module according to the thickness or hardness of the materials to be printed.

Accordingly, the present invention can provide a height-adjusting foolproof apparatus used in a large ink-jet printer, which has simple structure and can preset the printing module at the corrected height according to the thickness or hardness of the materials to be printed. It is new and can be put into industrial use.

Although the embodiments of the present invention have been described in detail, many modifications and variations may be made by those skilled in the art from the disclosures hereinabove. Therefore, It should be understood that different modifications and variations could be made from the disclosures mentioned above by the people familiar in the art, without departing the spirit of the present invention.

What is claimed is:

1. A height-adjusting foolproof apparatus for a printing module used in a large ink-jet printer, comprising:
a first adjusting member in connection with the printing module for moving the printing module vertically during adjustment; and
a second adjusting member fixed in the printer for presetting the height of the printing module according to the thickness or hardness of materials, wherein after the second adjusting member is pulled at the preset height, the first adjusting member is leveled downward until it is against a protrusion of the second adjusting member, and the printing module is pulled at the preset height.

2. The height-adjusting foolproof apparatus as claimed in claim 1, wherein the first adjusting member further includes:
a turnable handle;
a first toothed rack, one end of which is in connection with the turnable handle; and
a nut, which is partially screwed with the first toothed rack and an unscrewed space therein is provided for covering the protrusion of the second adjusting member;
the first toothed rack is leveled downward together with the nut by rotating the turnable handle until the protrusion is covered by the unscrewed space.

3. The height-adjusting foolproof apparatus as claimed in claim 2, wherein the second adjusting member is fixed to the printer via a base and a second toothed rack; the base is fixed to the printer and the second adjusting member is in connection with the base via the second toothed rack, and the second adjusting member is screwed with the toothed rack, so that the height of the printing module can be preset by moving the second adjusting member vertically.

4. The height-adjusting foolproof apparatus as claimed in claim 1, wherein the second adjusting member further includes an indicator and the printer is further disposed with a ruler corresponding to the indicator and having scale thereon; during the second adjusting member is adjusted, the height of the printing module can be indicated by the indicator and the ruler.
